(19) United States
(12) Patent Application Publication
(10) Pub. No.: US 2016/0073815 A1
(43) Pub. Date: Mar. 17, 2016

(54) EGG POACHING DEVICE

(71) Applicant: Enhanced Product Development, Minneapolis, MN (US)

(72) Inventors: Trevor Lambert, Brooklyn Park, MN (US); Michael Store, Coon Rapids, MN (US); Ryan Ellsworth, Minneapolis, MN (US)

(21) Appl. No.: 14/855,119

(22) Filed: Sep. 15, 2015

Related U.S. Application Data
(60) Provisional application No. 62/051,151, filed on Sep. 16, 2014.

(51) Int. Cl. A47J 29/02

(52) U.S. Cl. CPC A47J 29/02

(57) ABSTRACT

Described herein is a cooking device primarily for making poached eggs. The invention is a floating cup member with a finned structure and slot openings located on the underside of the cup to create a rotation in boiling water while an egg is being cooked by the boiling water flowing over and around the egg. The cup member's rotation promotes hot water circulation within the cup to properly poach an egg, while the structure of the cup keeps the egg white intact and prevents it from seeping into the cooking water.

### PRIORITY CLAIM

This nonprovisional patent application claims the benefit of and priority to, under 35 USC §119(e), U.S. Provisional Patent Application No. 62/051,151, filed Sep. 16, 2014, entitled “EGG POACHING DEVICE,” the entirety of which is incorporated herein by reference.

### FIELD OF THE INVENTION

The invention relates generally to a cooking device for making eggs.

### BACKGROUND

Currently there are a number of solutions for cooking poached eggs. One of these solutions attempts to cook the eggs in a pan filled with water without any assistance of an egg containing device, but this solution fails to meet the needs of the consumer because the challenge in cooking a poached egg is keeping the egg whites together (keeping the egg intact) and not letting the whites dissipate into the water. Other solutions attempt to sell sole-purpose appliances or microwaveable devices that cook an egg with a poached like texture, but these solutions are similarly unable to meet the needs of the consumer because the eggs cooked by these methods may require the use of butter or cooking sprays to avoid sticking, hence defeating the purpose of a healthy meal item, and often have a tougher and overcooked texture than poached. Still other solutions seek to sell floating cups, such as those disclosed in U.S. Pat. Nos. 7,754,261 and 8,460,729 in an attempt to contain the eggs intact in the pan of boiling water, but these devices also fail to meet needs of the consumer because these closed cups merely hold the eggs and do not allow the egg to actually touch the water. Attempting to “poach” the egg by heat conduction through the cup sidewalls will not only take longer but will result in eggs with a tough texture and sticking of the egg to the sidewalls.

### SUMMARY

It would be advantageous to have an apparatus, as described herein that is made of a non-stick material such as plastic or silicone to prevent eggs from sticking to the egg cooking device. Furthermore, it would also be advantageous to have an apparatus, as described herein that is a cup that floats in a pan of water that holds the egg to be poached. Still further, it would be advantageous for the egg holding apparatus to have a rotating motion while the eggs are cooking. Therefore, there currently exists a need in the market for an apparatus, as described herein in one example embodiment, that is a plastic or cooking-grade silicone (or Teflon coated metal cup or similar material) floating cup with fins or blades formed underneath to catch the rising bubbles and turbulent movement of the near boiling water. The floating cup holds the egg near the water surface and rotates with the help of the fins or blades, thereby allowing the water to enter and heat the entire egg (yolk and egg white) within the cup. In this example embodiment, the fins or blades are configured so as to move the cup in a clockwise direction, which promotes movement of the contents within the cup inward so as to keep the egg intact. Apertures or elongated openings located at the bottom of the cup and near the fins promote hot water flow over the top and around the egg to promote cooking as the cup is spinning while floating on the water surface. The user can visually determine when the egg is cooked to the preferred texture, at which time the floating cup with the poached egg is removed from the pan and egg is able to slide out intact out of the cup and onto a dish. The cooking device described herein also provides an easy method for removing the egg from the water without puncturing the egg or ruining its appearance.

In one example embodiment, an egg poaching cooking device is provided that includes a concave member having a bottom, a sidewall extending upwardly from the bottom, and an open end disposed at a top portion of the sidewall, the concave member having a longitudinal axis disposed through a center of the bottom. The egg poaching device further includes a finned structure protruding from an outside surface of the bottom of the concave member and having at least one set of opposing ends parallel with the longitudinal axis of the concave member, wherein the at least one set of opposing ends of the finned structure include at least a first and a second curved fin member, each curved fin member being disposed opposite and equidistant from the other and configured to promote clockwise rotation of the concave member when the at least one set of opposing ends are exposed to a moving liquid. The poaching device also includes a plurality of openings formed through the sidewall which allow the moving fluid to continuously flow through the concave member. In a related embodiment, the top portion of the sidewall is comprised of a hollow rim member or tube member, the tube member including a top and bottom portion that trap air therebetween when joined so as to promote flotation and inhibit moving fluid from flowing over the top portion of the sidewall. In yet another related embodiment, the slots or openings do not extend to the bottom of the concave member so as to assist in keeping the contents intact within the cooking device (such as the egg whites).

The cooking device described herein is not limited to cooking eggs and can be used to cook other food items that can be cooked in boiling water or any other broth or light sauce (or gravy). For instance, cut or mixed vegetables (e.g., peas and carrots), sole vegetables such as corn giblets, cut up chicken or beef and other food items can be placed in the floating cup for cooking (similar to fondue cooking). In the case of fondue cooking, if the user wants to avoid the fondue sticks or elongated pronged utensils the cooking device provided herein is an excellent alternative. Additionally, the device can be used as a stirring aid for pastas, rice and other foodstuffs that are boiled in water.

In a related embodiment, the cup/bowl and fin assembly is configured into 2 separable items that snap together and is not limited to a single molded or formed member. In yet another related embodiment, the entire cup/fin assembly is formed to be a larger structure to accommodate larger food items (or more in quantity) for cooking these food items in hot water, broth or any other cooking liquid or light sauce (or gravy) that promotes rotation or swirling of the cup in the cooking liquid. Non-stick materials keep the egg and other food items from sticking to the floating cooking cup while being removed from the cooking water and being removed from the poaching or cooking device. In a related embodiment, the cup-shaped cooking device can be used to slowly introduce other ingredients such butter or spices in boiling water for soup or gravy.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 illustrates an example embodiment of a top perspective view of a cup-shaped cooking device;

FIG. 2 illustrates an example embodiment of a bottom perspective view of the cup-shaped cooking device.

FIG. 3 illustrates an example embodiment of a top perspective view of the cup-shaped cooking device illustrating the rotational movement caused by fluid flow and the force on a food item inside the cooking device;

FIG. 4 illustrates an example embodiment of a bottom view of the cup-shaped cooking device with a finned structure and openings for permitting fluid flow;

FIG. 5 illustrates an example embodiment of a top perspective cutaway view of the cup-shaped cooking device;

FIG. 6 illustrates a second example embodiment of a top perspective view of a cup-shaped cooking device having substantially triangularly shaped fin members;

FIG. 7 illustrates the second example embodiment of a bottom perspective view of the cup-shaped cooking device having the substantially triangularly shaped fin members;

FIG. 8 illustrates a third example embodiment of a top perspective view of the cup-shaped cooking device with a varied-shaped fin member design that is reduced in size as they approach a top portion of the concave member;

FIG. 9 illustrates the third example embodiment of a side view of the cup-shaped cooking device;

FIG. 10 illustrates the third example embodiment of a bottom perspective view of the cup-shaped cooking device;

FIG. 11 illustrates a bottom perspective view of a fourth example embodiment of the cup-shaped cooking device without a smooth upper portion of the sidewall and slight curvature in the fin members;

FIG. 12 illustrates a top view of the fourth example embodiment of the cup-shaped cooking device illustrating the openings on the bottom of the concave member.

FIG. 13 illustrates a perspective view of a fifth embodiment of an egg poaching or cooking device having a two-piece top portion of an upper rim or side wall forming a hollow cavity that promotes flotation.

FIG. 14 illustrates a side exploded view of the fifth embodiment of a two-piece top portion of the upper rim portion forming the hollow cavity that promotes flotation; and

FIGS. 15 and 16 illustrate a top view and a bottom view, respectively, of the fifth embodiment of the cooking device.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments of the invention provide a concave or cup-shaped (or circular-shaped) device that holds an egg during the egg poaching cooking process. The apparatus has a fin or blade attachment on the bottom of the egg holding cup, which creates movement to rotate the cup while the egg is poaching in boiling water. The egg poacher device moves due to the finned structure on the underside of the cup, which also catches rising bubbles and pushes the blades to create the rotational motion. In one example embodiment, the curved fins of the finned structure are oriented to create a clockwise rotational movement for the cooking device so as to assure the egg whites adhere together and stay intact during the cooking process of egg poaching.

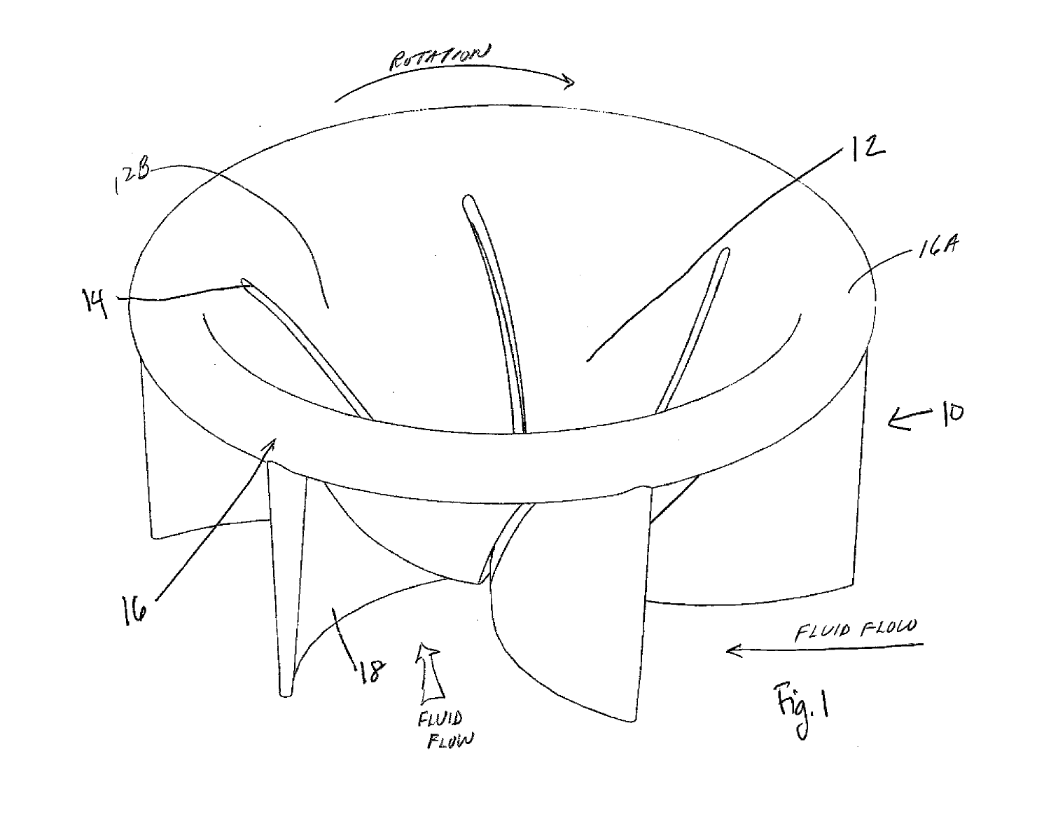

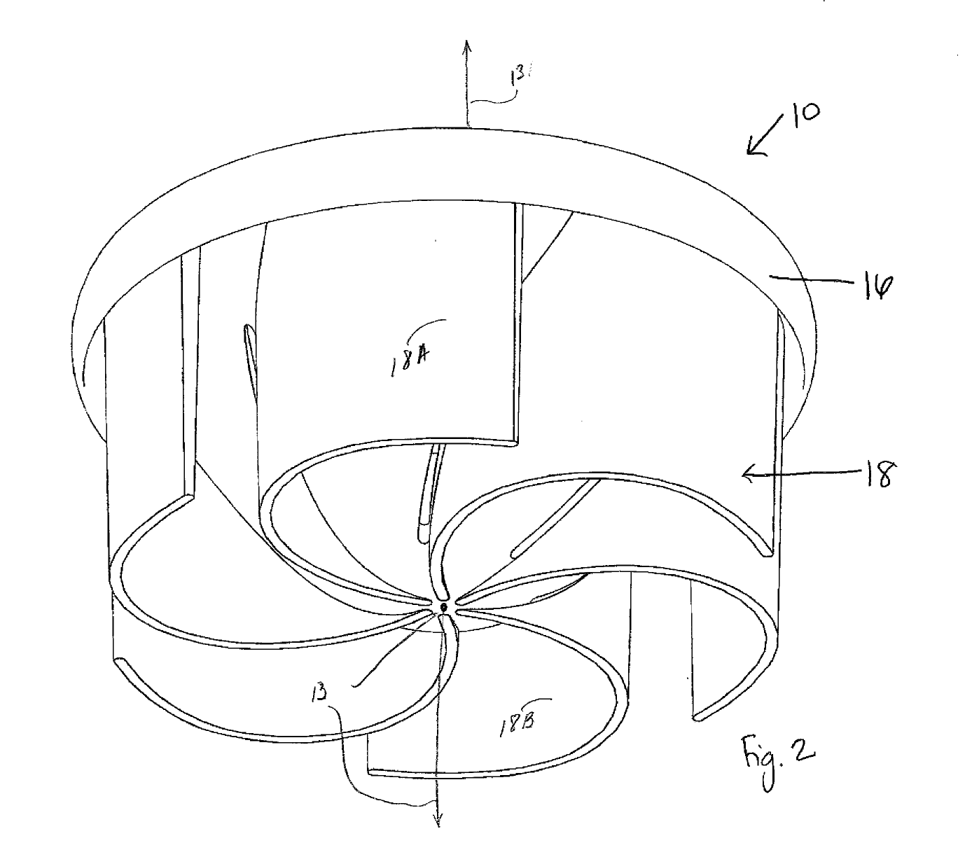

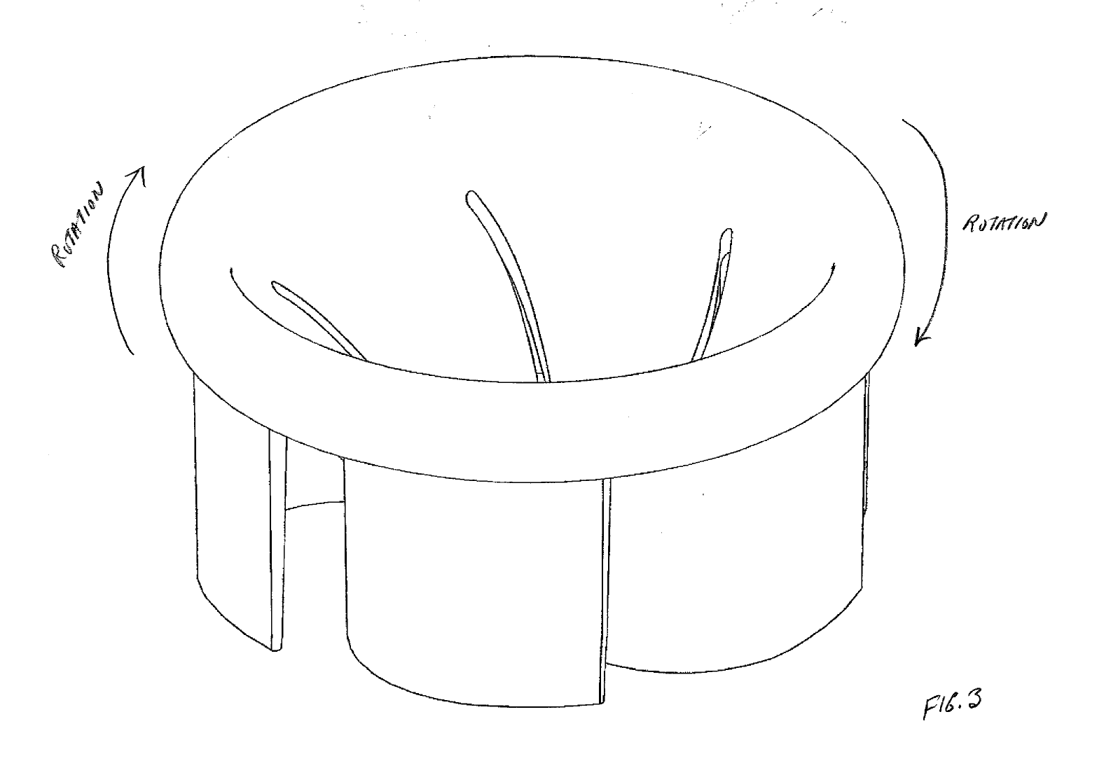

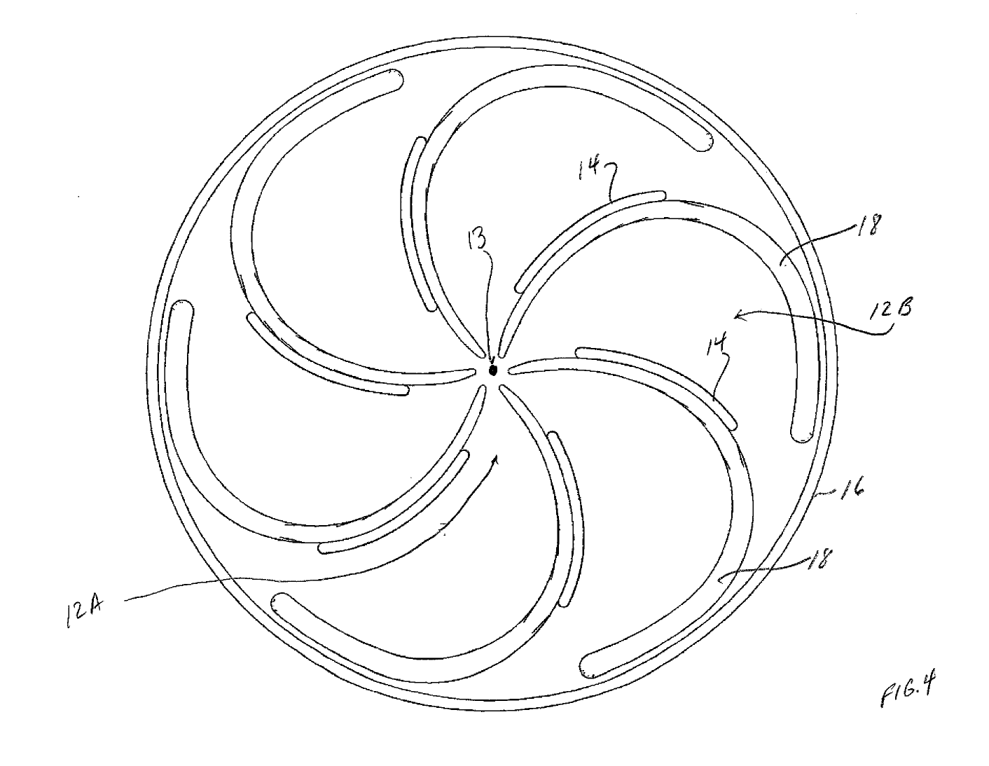

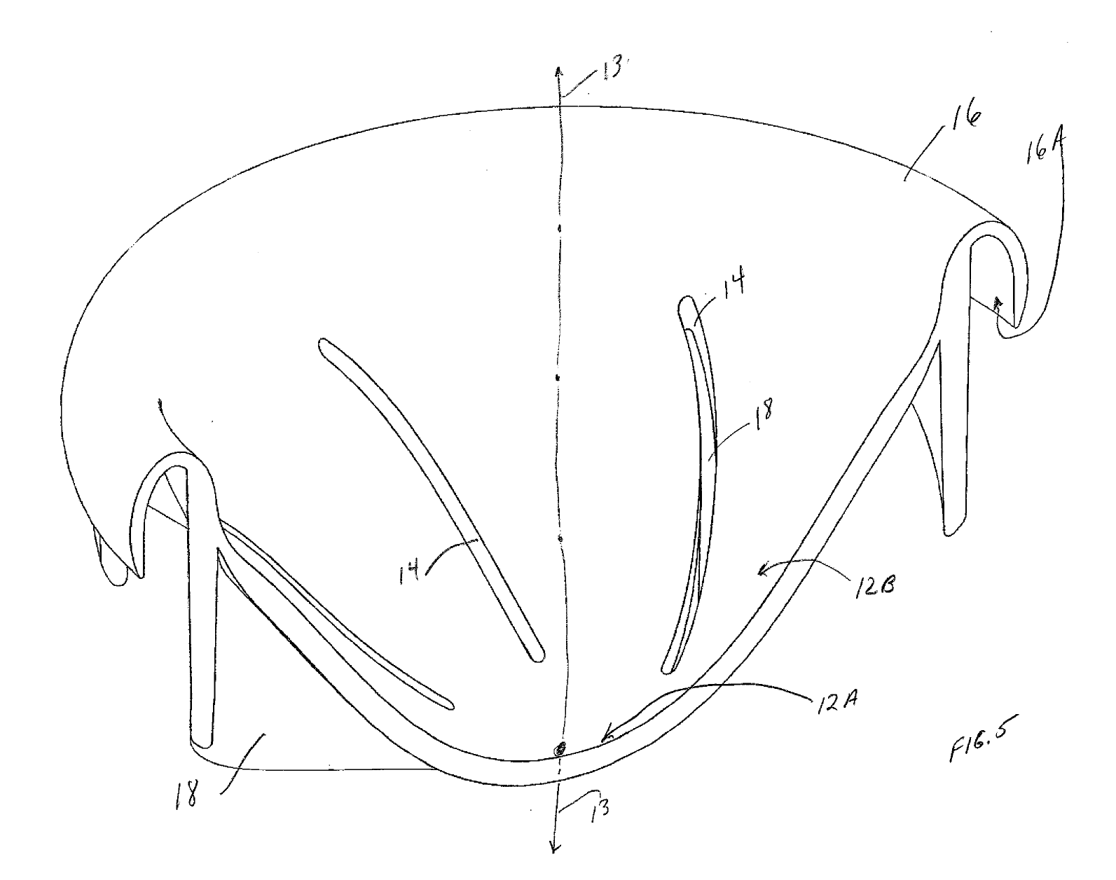

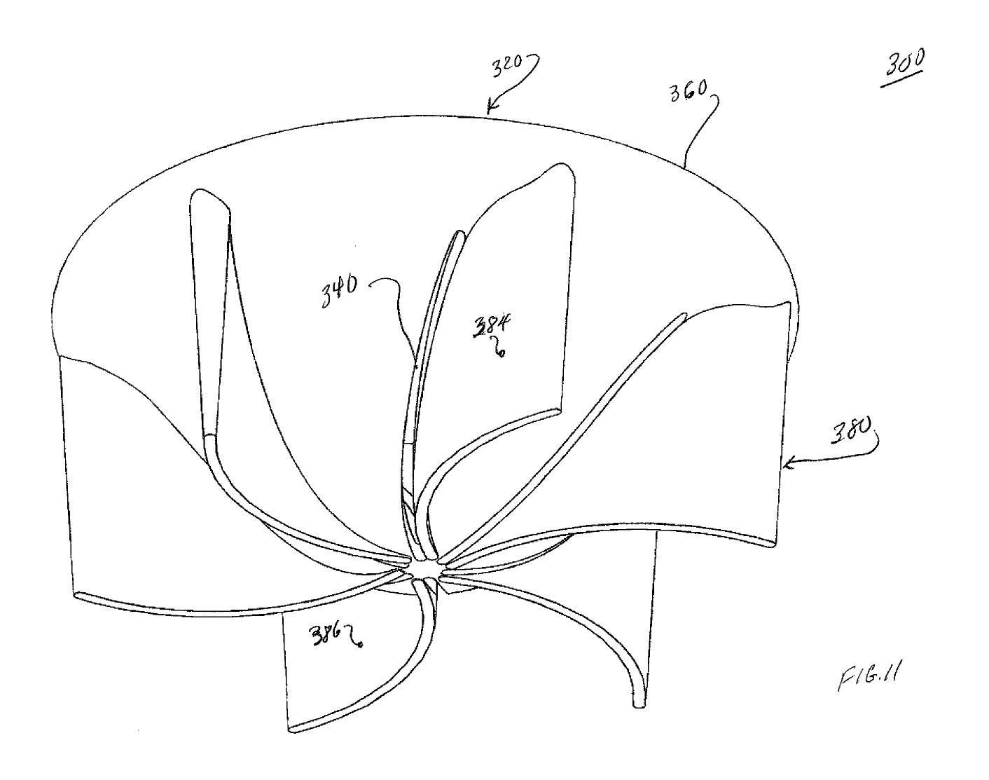

Referring now to the figures, FIG. 1 illustrates a top view and FIG. 5 illustrates a cutaway view of an example embodiment of a floating cooking cup or concave device 10, while FIG. 2 illustrates an example embodiment of a bottom perspective view of the cup-shaped cooking device. FIG. 3 illustrates an example embodiment of a top perspective view of the cup-shaped cooking device illustrating the rotational movement caused by fluid flow and the force on a food item inside the cooking device and FIG. 4 illustrates an example embodiment of a bottom view of the cup-shaped cooking device with a finned structure and openings for permitting fluid flow. In this example embodiment, floating cup or cooking device 10 includes a concave member 12 generally of a concave shape or cup design that includes a plurality of slots or elongated openings 14 on sidewall 12B which comes up from bottom 12A of concave member 12. In this example embodiment, slots 14 are large/wide enough to allow water to flow in and out, but small/narrow enough to keep an egg in cup or concave member 12. Openings 14 can also vary in length along sidewall 12B, as they may extend from bottom 12A of cup or concave member 12 upward towards a top portion or lip 16 of concave member 12 (see also FIG. 11 for another view of openings 14). In a related example embodiments, openings 14 are formed through the sidewall but not through the bottom of the concave member and can be formed of various sizes and be spread in different patterns across sidewall 12B so as to let the boiling fluid flow continuously across and the around the food item or egg to be cooked.

In this example embodiment, concave member 12 further includes a finned structure or a plurality of fins or blades 18. Each fin of the plurality of fins 18 is configured in a curved shape so as to catch the bubbles and turbulent boiling water (see arrows indicating Fluid Flow), thereby promoting the clockwise (or counter-clockwise, depending on the direction of the fins) rotational movement of (arrow on top and sides of device 10) and the force on cup or cooking device 10. In this example embodiment, top portion or lip or rim 16 is generally a convex shape (see FIG. 5), or opposite that of concave member 12, as lip 16 functions to help keep cup device 10 afloat and to catch the turbulent water and bubbles thereby facilitating a rotational motion or movement in a clockwise direction of cup device 10. In a related embodiment, rim 16 is formed to be a flat surface that extends away from concave member 12.

FIGS. 2 and 4 illustrate, in one example embodiment, the bottom of cooking device 10 with the plurality of fins 18 that extend from bottom 12A of concave member 12. For purposes of proper orientation, a longitudinal axis 13 that passes through bottom 12A and concave member 12 is defined. Using axis 13 as a reference, each of fins 18 as well as an outer surface 18A and an inner surface 18B are parallel with longitudinal axis 13. In this example embodiment, fins 18 have a curvature and arc or curve around and towards center axis 18 of floating cup or cooking device 10 to generate rotation movement. In related embodiments, fins 18 take other forms or shapes that promote spinning, rotation and/or flotation in water. In related embodiments, floating cup device 10 is preferably made from lightweight materials, such as heat resistant plastic and silicone, and non-stick materials. Other example materials include aluminum, ceramic, or Pyrex® glass (or other materials with stick-resistant coatings).

In a related example embodiment, cooking device 10 is configured to only have two-fins or blades 18, disposed about 180 degrees radially from each other so as to keep the balanced rotation but the speed of rotation may be slowed down. In yet another example embodiment, cooking device 10 is configured to have four fins or blades, with each being disposed about 90 degrees radially from each other. Depending on the application and type of food being cooked, fins can be added or removed to speed up or slow down the rotational movement. In a related embodiment, cooking device 10 is configured into a cup or bowl portion and a blade assembly that snaps onto the cup portion, thereby facilitating the use of various blade assemblies with a different number of blades (2, 4, 6, etc.). In a related embodiment, the floating cup device 10 is put into a large cup of hot or warm water and can be cooked in a microwave to promote rotational movement and thereby even cooking.

In a related embodiment, the egg poaching cooking assembly described herein has a concave member which has a shape selected from the group consisting of a cup, a bowl, a cylinder and a cone-shaped structure. In yet another related embodiment, egg poaching cooking assembly 10 the finned structure and the concave member are made as separate members but the finned structure can be adhered to (or snap-fit on) the bottom of the concave member to form a single egg poaching cooking device.

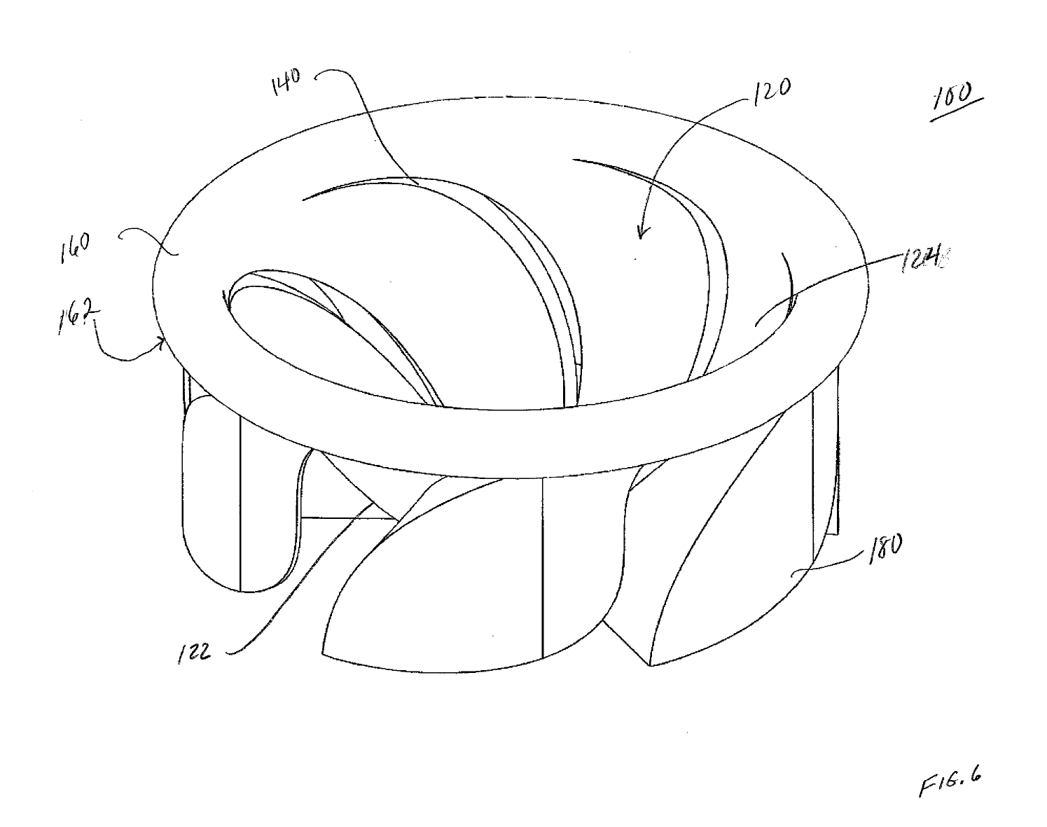

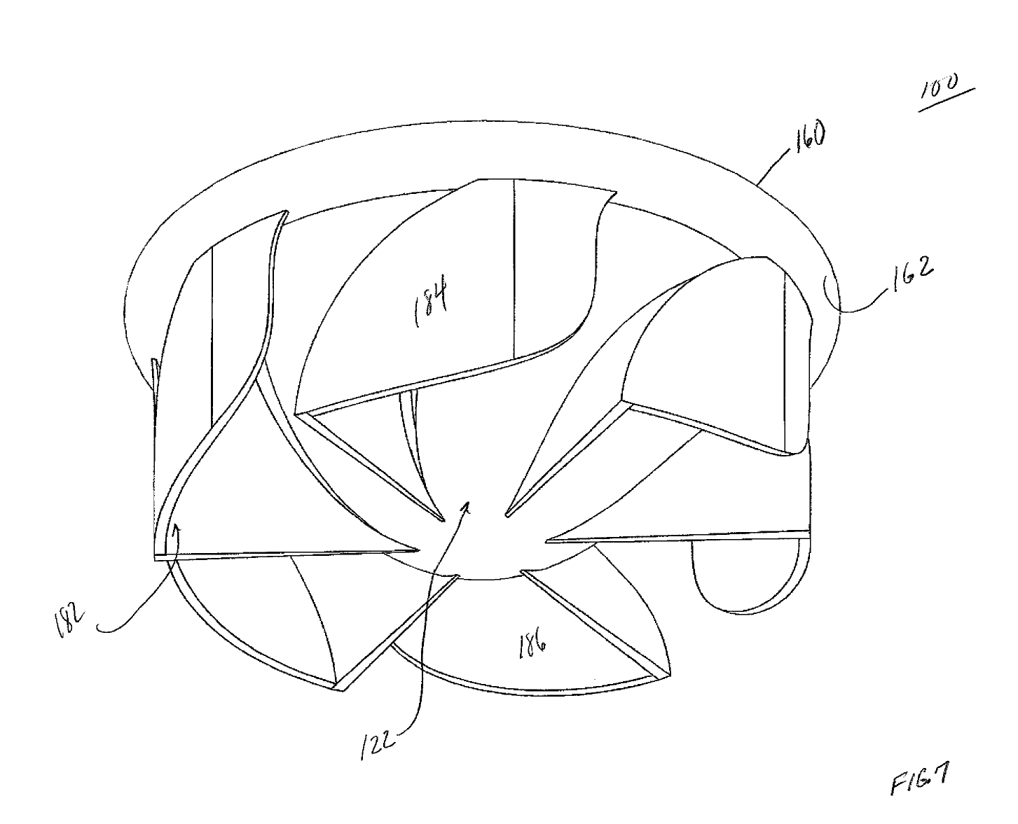

Referring now to FIGS. 6 and 7, there is illustrated a second example embodiment of a top and bottom perspective views of a cup-shaped cooking device 100 having substantially triangularly shaped fin members 180. Similar to the first embodiment of a cooking device 10, cooking device 100 includes a concave member 120, with a bottom 122, a sidewall 124, a plurality of openings 140 on sidewall 124, with sidewall 124 from bottom 122 to a top portion 160 and a convex rig 162. In this example embodiment, substantially triangular structure 180 include a plurality of triangularly formed fin members (with an outer surface 184 and an inner surface 186) that are configured to promote clockwise rotation of the concave member as the moving fluid contacts inner triangular apex or surface 182 of the triangular structure of each of fin members 180.

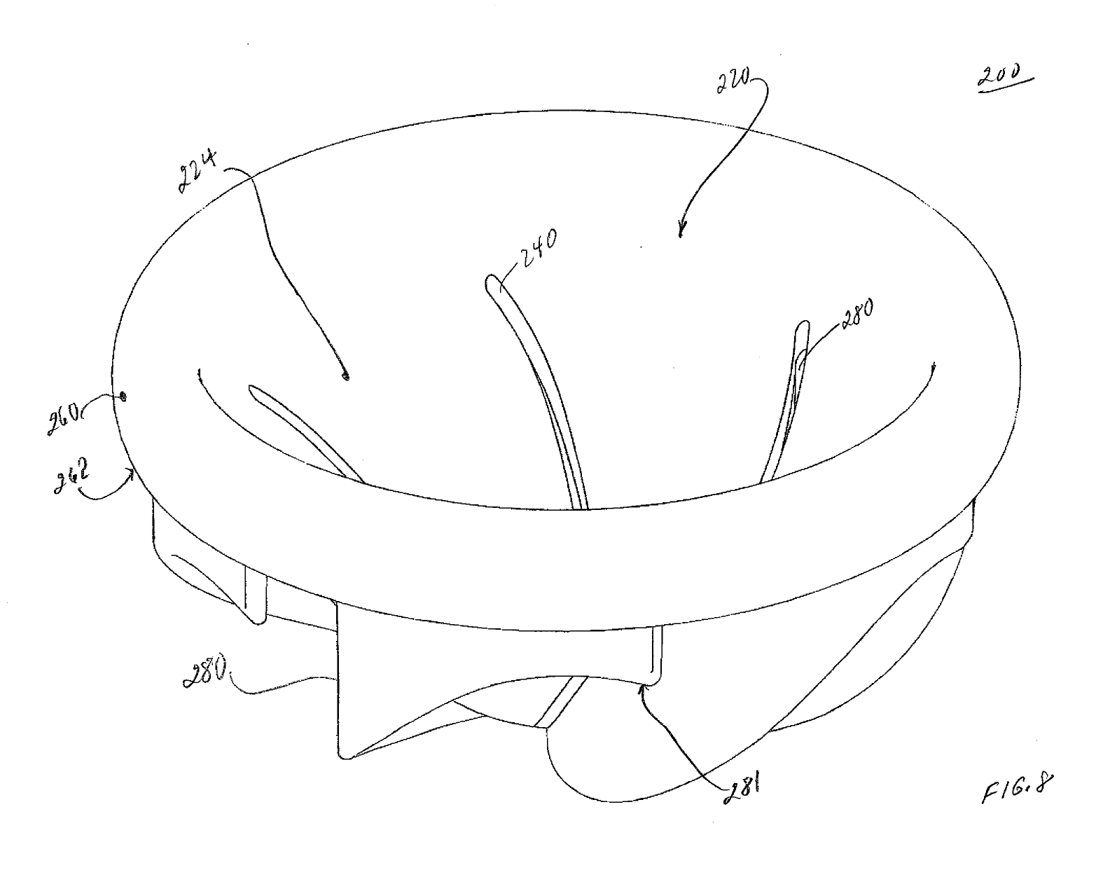

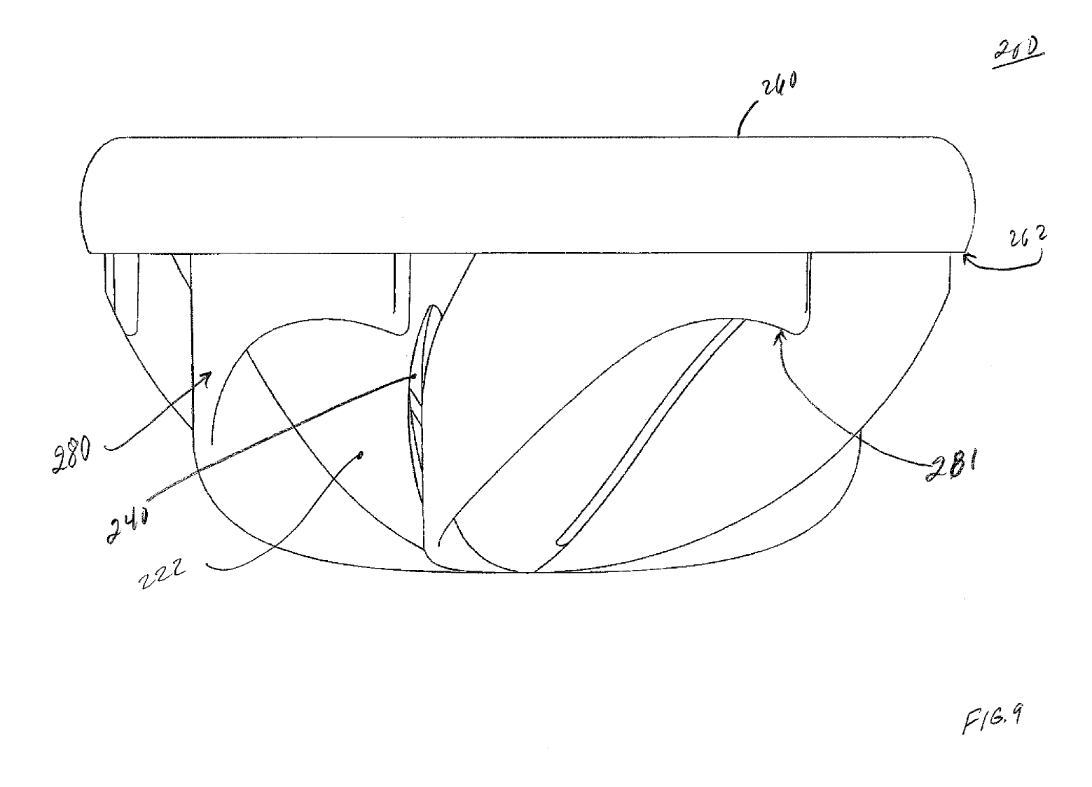

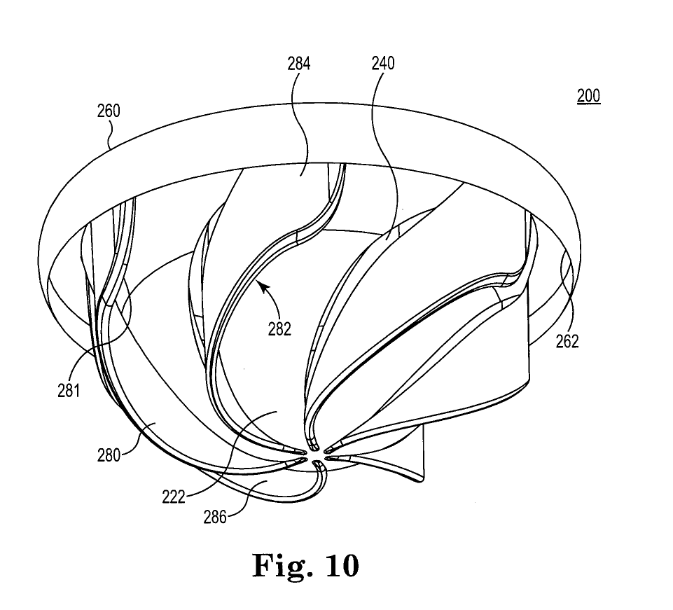

Referring now to FIGS. 8-10, there is illustrated a third example embodiment of a top and bottom perspective views and a side view of the cup-shaped cooking device 200 with a varied-shaped fin member design 280 that is reduced in size 281 as the fin members approach a top portion of concave member 220. Similar to the first and second embodiments of a cooking devices 10 and 100, cooking device 200 includes a concave member 220, with a bottom 222, a sidewall 224, a plurality of openings 240 on sidewall 224, with sidewall 224 from bottom 222 to a top portion 260 and a convex ridge 262. In this example embodiment, varied or angled shaped finned structure 280 include a plurality of angled formed fin members (with an outer surface 284 and an inner surface 286) that are configured to promote clockwise rotation of the concave member as the moving fluid contacts inner surface 282 of the angled shaped structure of each of fin members 280.

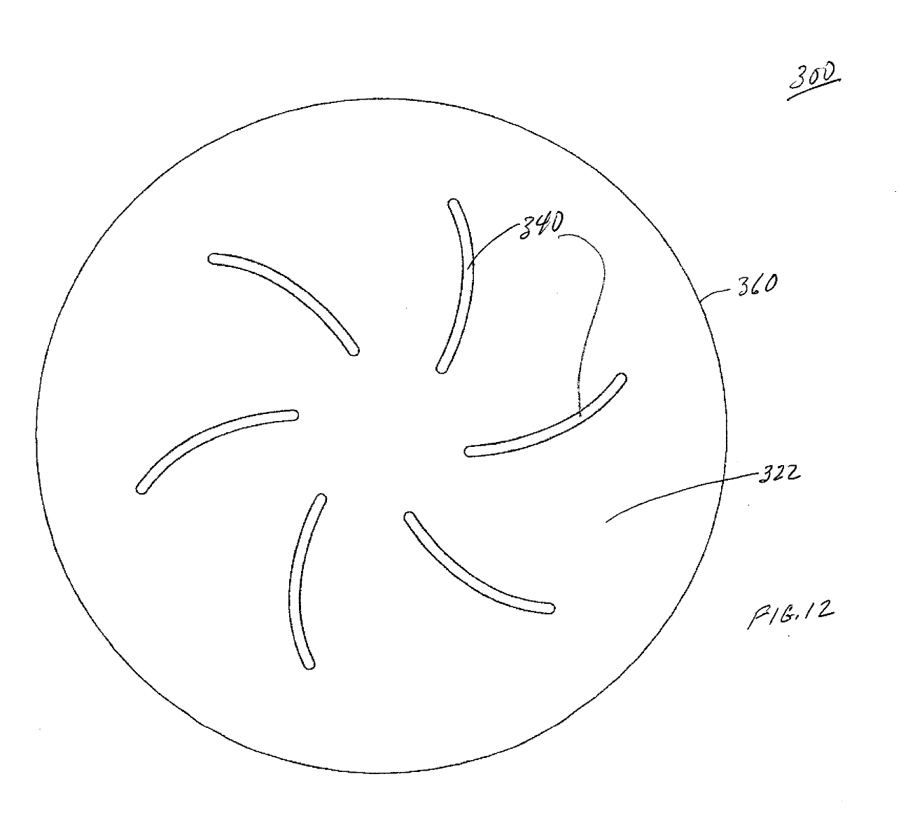

Referring now to FIGS. 11 and 12, there is illustrated a fourth example embodiment of bottom and top perspective views of the cup-shaped cooking device without a smooth upper portion of the sidewall and slight curvature in the fin members as well as the openings on the bottom of the concave member. Similar to the above described embodiments of the cooking devices disclosed herein, cooking device 300 includes a concave member 320, with a bottom 322, a sidewall 324, a plurality of openings 340 on sidewall 324, with sidewall 324 from bottom 322 to a top portion 360, an edge 362 and a finned structure 380. In this example embodiment, finned structure 380 include a plurality of slightly curved formed fin members, with an outer surface 384 and an inner surface 386, that are configured to promote clockwise rotation of the concave member as a moving fluid contacts these surfaces of each of fin members 180. In its most simple form (especially for mold manufacturing and material costs), cooking device 300 eliminates the convex ridge of the other embodiments while still providing the cooking benefits described above.

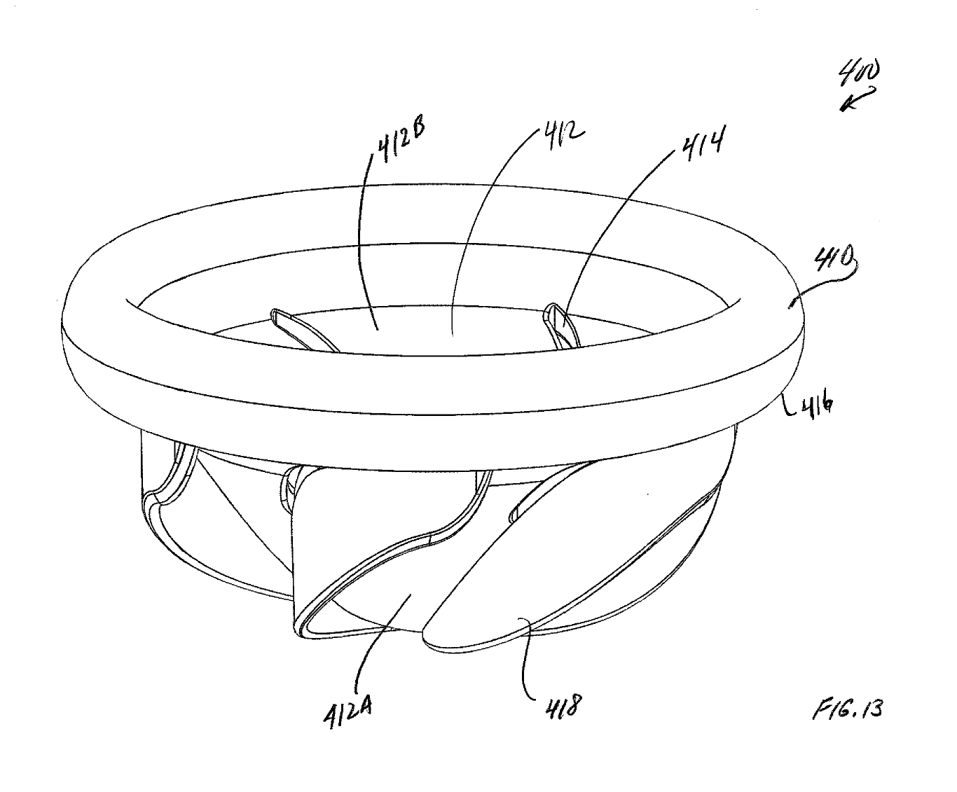

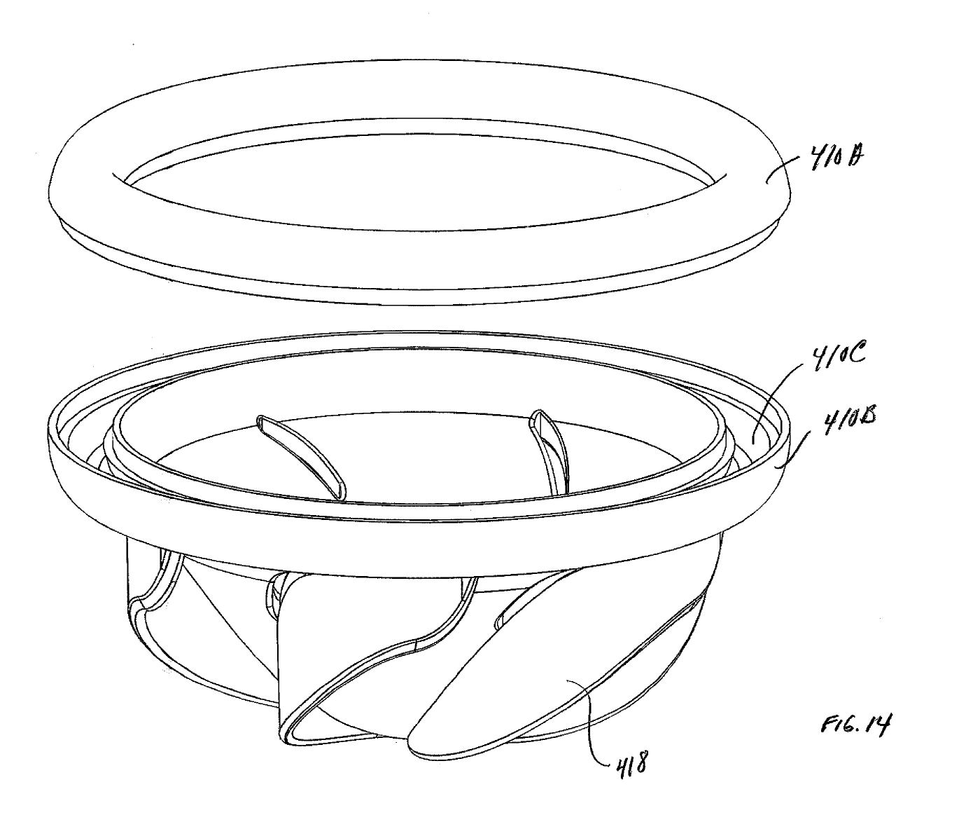

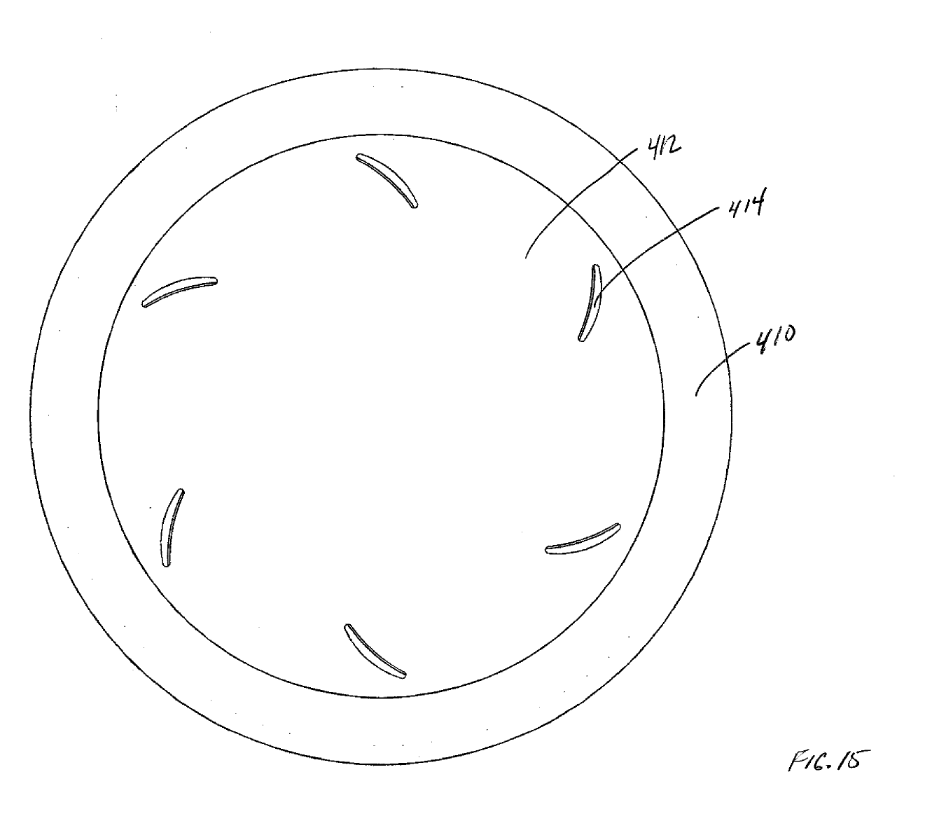

Referring now to FIGS. 13-16, there is illustrated a fifth example embodiment of a cooking device 400 according to the teachings herein. In this example embodiment, floating cup or cooking device 400 includes a tubular rim member or portion 410 disposed on a concave member 412 generally of a concave shape or cup design that includes a plurality of slots or elongated openings 414 on sidewall 412B which comes up from bottom 412A of concave member 412. In this example embodiment, slots 414 are large/wide enough to allow water to flow in and out, but small/narrow enough to keep an egg in cup or concave member 412. Openings 414 are formed through the sidewall but not through to the bottom of the concave member, as illustrated in FIG. 15 of a top view of the openings in the concave member, and can be formed of various sizes and be spread in different patterns across sidewall 412B so as to let the boiling fluid flow continuously across and the around the food item or egg to be cooked. In related example embodiments, openings 414 can also vary in length along sidewall 412B, as they may extend from bottom 412A of cup or concave member 412 upward towards rim member 410.

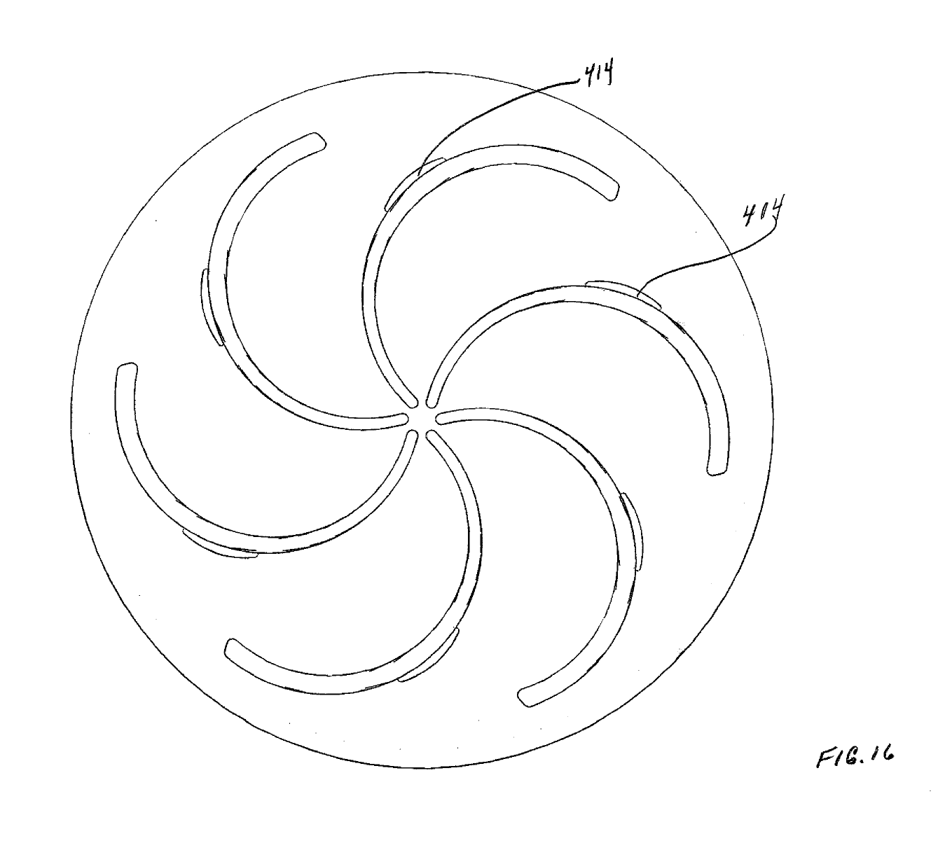

In this example embodiment, concave member 412 further includes a finned structure or a plurality of fins or blades 418. Each fin of the plurality of fins 418 is configured in a curved shape so as to catch the bubbles and turbulent boiling water (see arrows indicating Fluid Flow in FIG. 1, for example), thereby promoting the clockwise (or counterclockwise if the fins in the opposite direction) rotational movement of (arrow on top and sides of device 10) on cup or cooking device 10. In this example embodiment, rim member 410, comprised of a top half 410A, a bottom half 410B and a cavity 410C form a flotation structure that facilitates easy flotation of device 400. Rim member 410 functions to help keep cup device 400 afloat and to catch the turbulent water and bubbles thereby facilitating a rotational motion or movement in either direction (depending on the curvature/direction of fins 418) of cup device 400. FIG. 16 illustrates a bottom view of cooking device 400 and the location and size of openings 414, which promote heated water or fluid flow while helping to keep the contents within device 400. In poaching an egg, locating the openings or slots high on the sidewall of device 400 helps to keep the egg white together during cooking and help to prevent egg white leakage. When device 400 is used for mixing in spices (or the melting of ingredients such as butter) slowly into a soup or stew, the upper slots help to slow down the water/fluid flow process.

The following example embodiment provides a cooking device and kitchen tool that is configurable for both clockwise and counterclockwise rotation and is available for many uses other than cooking food items, such as for slowly adding spices, herbs and condiments to soups and sauces or simply acting as an upper surface stirring device to move the cooking liquid around in a pot or vessel. In this example embodiment, a cooking assembly includes a concave member having a bottom, a sidewall extending upwardly from the bottom, and an open end disposed at a top portion of the sidewall, the concave member having a longitudinal axis disposed through a center of the bottom. Further, the device includes a finned structure protruding from an outside surface of the bottom of the concave member parallel with the longitudinal axis of the concave member, the finned structure having opposing ends configured to promote rotation of the concave member when the opposing ends are exposed to a moving liquid. In addition, a plurality of openings are included that are formed through the sidewall which allow the moving fluid to continuously flow through the concave member. In this example embodiment, the cooking assembly has the opposing ends of the finned structure include at least a first and a second substantially curved fin member, wherein each curved fin member being is disposed opposite and equidistant from the other and wherein a curvature of each of the curved fin members are configured to promote clockwise rotation of the concave member as the moving fluid contacts an inner surface of the curvature of each of the fin members. In a related embodiment, the cooking assembly has a curvature of each of the curved fin members that instead are configured to promote counterclockwise rotation of the concave member as the moving fluid contacts an inner surface of the curvature of each of the fin members. In a related embodiment, the cooking assembly has a plurality of openings that include slots or elongated openings extending from the bottom of the concave member upward towards the top portion of the sidewall of the concave member. In a related embodiment, the plurality of openings are instead formed through the sidewall but not through the bottom of the concave member.

In a related embodiment, the cooking assembly has a curved finned structure that is comprised of pairs of curved fin members protruding from the outside surface of the bottom of the concave member, wherein the pairs are selected from the group consisting of two pairs, four pairs and six pairs of curved fin members. In another related embodiment, the cooking assembly has a substantially triangular finned structure of each of the curved fin members are configured to promote clockwise rotation of the concave member as the moving fluid contacts an inner surface of the triangular structure of each of the fin members. In another embodiment, the cooking assembly has a top portion of the sidewall that is comprised of a convex rim that bounds the concave member and inhibits the moving fluid from flowing over the top portion of the sidewall while in another embodiment the top portion of the sidewall is comprised of a flat surface rim that bounds the concave member and inhibits the moving fluid from flowing over the top portion of the sidewall.

Various related embodiments of the invention are also described in Appendix A, which is incorporated herein by reference in its entirety. The following patents are incorporated by reference in their entireties: U.S. Pat. Nos. US2012/0207891; D691,844; and D381,554.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

We claim:

1. An egg poaching cooking assembly comprising:
a concave member having a bottom, a sidewall extending upwardly from the bottom, and an open end disposed at a top portion of the sidewall, the concave member having a longitudinal axis disposed through a center of the bottom;
a finned structure protruding from an outside surface of the bottom of the concave member parallel with the longitudinal axis of the concave member, the finned structure having opposing ends configured to promote rotation of the concave member when the opposing ends are exposed to a moving liquid, wherein the opposing ends of the finned structure include at least a first and a second curved fin member, each curved fin member being is disposed opposite and equidistant from the other; and
a plurality of openings formed through the sidewall allowing the moving fluid to continuously flow through the concave member.

2. The egg poaching cooking assembly according to claim 1, wherein a curvature of each of the curved fin members are configured to promote clockwise or counter-clockwise rotation of the concave member.

3. The egg poaching cooking assembly according to claim 2, wherein the curved finned structure is comprised of pairs of curved fin members protruding from the outside surface of the bottom of the concave member, wherein the pairs are selected from the group consisting of two pairs, four pairs and six pairs of curved fin members.

4. The egg poaching cooking assembly according to claim 1, wherein the plurality of openings include slots or elongated openings extending from the bottom of the concave member upward towards the top portion of the sidewall of the concave member.

5. The egg poaching cooking assembly according to claim 2, wherein the top portion of the sidewall is comprised of a convex rim that bounds the concave member and inhibits the moving fluid from flowing over the top portion of the sidewall.

6. The egg poaching cooking assembly according to claim 1, wherein the top portion of the sidewall is comprised of a hollow rim member or tube member, the tube member including a top and bottom portion that trap air therebetween when joined so as to promote flotation and inhibit moving fluid from flowing over the top portion of the sidewall.

7. The egg poaching cooking assembly according to claim 1, wherein a substantially triangular structure of each of the curved fin members are configured to promote clockwise rotation of the concave member as the moving fluid contacts an inner surface of the triangular structure of each of the fin members.

8. The egg poaching cooking assembly according to claim 1, wherein the openings are formed through the sidewall but not through to the bottom of the concave member.

9. The egg poaching cooking assembly according to claim 1, wherein the concave member has a shape selected from the group consisting of a cup, a bowl, a cylinder and a cone-shaped structure.

10. The egg poaching cooking assembly according to claim 3, wherein the finned structure and the concave member are separate members and wherein the finned structure is configured to adhere to the bottom of the concave member to form an egg poaching cooking device.

11. A cooking assembly comprising:
a concave member having a bottom, a sidewall extending upwardly from the bottom, and an open end disposed at a top portion of the sidewall, the concave member having a longitudinal axis disposed through a center of the bottom;
a finned structure protruding from an outside surface of the bottom of the concave member parallel with the longitudinal axis of the concave member, the finned structure having opposing ends configured to promote rotation of the concave member when the opposing ends are exposed to a moving liquid; and
a plurality of openings formed through the sidewall allowing the moving fluid to continuously flow through the concave member.

12. The cooking assembly according to claim 11, wherein the opposing ends of the finned structure include at least a first and a second substantially curved fin member, each curved fin member being is disposed opposite and equidistant from the other.

13. The cooking assembly according to claim 12, wherein a curvature of each of the curved fin members are configured to promote rotation of the concave member as the moving fluid contacts an inner surface of the curvature of each of the fin members.

14. The cooking assembly according to claim 11, wherein the top portion of the sidewall is comprised of a hollow rim member or tube member, the tube member including a top and bottom portion that trap air therebetween when joined so as to promote flotation and inhibit moving fluid from flowing over the top portion of the sidewall.

15. The cooking assembly according to claim 13, wherein the curved finned structure is comprised of pairs of curved fin members protruding from the outside surface of the bottom of the concave member, wherein the pairs are selected from the group consisting of two pairs, four pairs and six pairs of curved fin members.

16. The cooking assembly according to claim 10, wherein the plurality of openings include slots or elongated openings extending from the bottom of the concave member upward towards the top portion of the sidewall of the concave member.

17. The cooking assembly according to claim 11, wherein the top portion of the sidewall is comprised of a convex rim that bounds the concave member and inhibits the moving fluid from flowing over the top portion of the sidewall.

18. The cooking assembly according to claim 11, wherein the top portion of the sidewall is comprised of a flat surface rim that bounds the concave member and inhibits the moving fluid from flowing over the top portion of the sidewall.

19. The cooking assembly according to claim 11, wherein the plurality of openings are formed through the sidewall but not through to the bottom of the concave member.

20. An egg poaching cooking device comprising:
a concave member having a bottom, a sidewall extending upwardly from the bottom, and an open end disposed at a top portion of the sidewall, the concave member having a longitudinal axis disposed through a center of the bottom;
a finned structure protruding from an outside surface of the bottom of the concave member and having at least one set of opposing ends parallel with the longitudinal axis of the concave member, wherein the at least one set of opposing ends of the finned structure include at least a first and a second curved fin member, each curved fin member being disposed opposite and equidistant from the other and configured to promote clockwise rotation of the concave member when the at least one set of opposing ends are exposed to a moving liquid; and
a plurality of openings formed through the sidewall allowing the moving fluid to continuously flow through the concave member.
